(19) United States
(12) Patent Application Publication
(10) Pub. No.: US 2021/0063172 A1
(43) Pub. Date: Mar. 4, 2021

(54) NAVIGATION SYSTEM AND METHOD USING DRONE

(71) Applicants: HYUNDAI MOTOR COMPANY, SEOUL (KR); KIA MOTORS CORPORATION, SEOUL (KR)

(72) Inventors: Jae Kwon JUNG, Yongin-si (KR); Ji Heon KIM, Gyeongsan-si (KR); Min Gu PARK, Pocheon-si (KR)

(73) Assignees: HYUNDAI MOTOR COMPANY, SEOUL (KR); KIA MOTORS CORPORATION, SEOUL (KR)

(21) Appl. No.: 16/805,193

(22) Filed: Feb. 28, 2020

(30) Foreign Application Priority Data
Sep. 2, 2019 (KR) 10-2019-0108366

(51) Int. Cl. G01C 21/34; G08G 1/01; G01C 21/36; B64C 39/02

(52) U.S. Cl. CPC G01C 21/3415; G08G 1/0141; B64C 2201/127; G01C 21/3667; B64C 39/024; G08G 1/0133

(57) ABSTRACT

A navigation system and a method using a drone are provided. The navigation system includes a communicator configured to communicate with the drone and a vehicle, storage configured to store traffic information and map information, and a processor configured to detect a congested section using the traffic information and the map information, or image information of the drone and to guide a detour lane or a detour route to the vehicle based on road information of the congested section obtained by the drone.

### CROSS-REFERENCE TO RELATED APPLICATION

The present application claims priority to and the benefit of Korean Patent Application No. 10-2019-0108366, filed on Sep. 2, 2019, which is incorporated herein by reference in its entirety.

### TECHNICAL FIELD

The present disclosure relates to a navigation system and a method using a drone.

### BACKGROUND

The statements in this section merely provide background information related to the present disclosure and may not constitute prior art.

In recent years, a navigation system collects traffic information on a road in real time and estimates an optimum route to a destination based on the collected traffic information and a current location of a vehicle. Such a navigation system collects and stores the traffic information of the road every update period, and estimates a route based on the stored traffic information. Therefore, it is difficult to estimate a route reflecting latest traffic information until a traffic information update time point.

In addition, because the existing navigation system only guides a road present in map data, when a driver is on a road that the driver has never been before, the driver is not able to use a shortcut that does not exist in the map data.

In addition, the existing navigation system collects the traffic information through collection devices such as a loop detector, an ultrasonic detector, an image detector, and/or an infrared light detector fixedly installed at a specified position on the road. Therefore, when a sudden situation such as an accident, landslide, or the like occurs in a road section in which the collection device is not installed, information about the sudden situation may not be provided.

### SUMMARY

An aspect of the present disclosure provides a navigation system and a method using a drone that obtain traffic information in real time without limiting a road section using the drone and reflect the obtained traffic information to guide a driving route.

Another aspect of the present disclosure provides a navigation system and a method using a drone that reflect a road that is not reflected on a map and traffic information of the corresponding road to guide a driving route.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, there is provided a navigation system including a communicator for communicating with a drone and a vehicle, storage for storing traffic information and map information, and a processor that detects a congested section using the traffic information and the map information, or image information of the drone and guides a detour lane or a detour route to the vehicle based on road information of the congested section obtained by the drone.

In one form of the present disclosure, the road information may include the image information captured through a camera mounted on the drone.

In one form of the present disclosure, the processor may analyze the image information to identify an accident occurrence in the congested section and to identify an accident lane.

In one form of the present disclosure, the processor may identify the detour lane for avoiding the accident lane and transmit the detour lane to the vehicle.

In one form of the present disclosure, the processor may determine one of the lanes having a vehicle driving speed equal to or greater than a first reference speed and having a vehicle driving speed that differs from the vehicle driving speed in the accident lane by more than the second reference speed as the detour lane.

In one form of the present disclosure, the processor may identify a detour road by associating the image information with the map information.

In one form of the present disclosure, the processor may extract a road from the image information, map the extracted road to the map information, and detect a road that does not exist in the map information as a new road.

In one form of the present disclosure, the processor may determine whether the new road is a road drivable by the vehicle and determines whether the new road is able to be used as a detour road.

In one form of the present disclosure, the processor may determine that the new road is able to be used as the detour road when an end-to-end of the new road is connected to a road on a route to a destination of the vehicle.

In one form of the present disclosure, the processor may generate the detour route using the new road as the detour road, generate a new driving route including the detour route to calculate a driving time, and provide the new driving route to the vehicle when the driving time of the new driving route is shorter than a driving time of an existing driving route of the vehicle.

According to another aspect of the present disclosure, there is provided a navigation method including detecting a congested section using traffic information and map information, or image information of a drone, obtaining road information of the congested section using the drone, and guiding a detour lane or a detour route to a vehicle based on the road information.

In one form of the present disclosure, the obtaining of the road information of the congested section may include obtaining image information around the congested section as the road information using a camera mounted on the drone.

In one form of the present disclosure, the guiding of the detour lane or the detour route to the vehicle may include analyzing the image information to identify an occurrence of an accident in the congested section, identifying an existence of the detour lane for avoiding an accident lane based on the image information when the occurrence of the accident is identified, and guiding the detour lane to the vehicle.

In one form of the present disclosure, the identifying of the existence of the detour lane may include distinguishing lanes in the congested section based on the image information to calculate a vehicle driving speed for each lane, and determining one of the lanes having the calculated vehicle driving speed equal to or greater than a first reference speed and having the calculated vehicle driving speed that differs from the calculated vehicle driving speed in the accident lane by more than the second reference speed as the detour lane.

In one form of the present disclosure, the guiding of the detour lane or the detour route to the vehicle may include identifying an existence of a new road in the image information by associating the image information with the map information, generating a new driving route to a destination of the vehicle using the new road, selecting one driving route by comparing an existing driving route of the vehicle with the new driving route based on a driving route selection criterion, and guiding the new driving route to the vehicle when the new driving route is selected.

In one form of the present disclosure, the identifying of the existence of the new road may include extracting a road from the image information, mapping the extracted road to the map information, and detecting a road that does not exist in the map information as the new road.

In one form of the present disclosure, the generating of the new driving route may include determining whether the new road is able to be used as a detour road, and generating the detour route using the new road as the detour road when the new road is able to be used as the detour road.

In one form of the present disclosure, the determining of whether the new road is able to be used as the detour road may include determining whether an end-to-end of the new road is connected to a road on a route to the destination of the vehicle, determining whether the vehicle is able to travel based on a road width and a road condition of the new road, and determining that the new road is able to be used as the detour road when the vehicle is able to travel.

In one form of the present disclosure, the selecting of the driving route may include comparing a driving time of the new driving route with a driving time of the existing driving route to select a driving route with shorter driving time.

According to another aspect of the present disclosure, there is provided a navigation system including a drone, a vehicle, and a navigation server connected with each other through a network, wherein the vehicle travels by receiving a second driving route including a detour lane or a detour route from the navigation server when a congested section occurs in front of the vehicle while traveling along a prestored first driving route, and wherein the detour lane or the detour route is generated based on road information of the congested section collected by the navigation server through the drone.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram illustrating a navigation system in one form of the present disclosure;

FIG. 2 is a block diagram illustrating a drone shown in FIG. 1;

FIG. 3 is a block diagram of a vehicle shown in FIG. 1;

FIG. 4 is a block diagram of a navigation server shown in FIG. 1; and

FIGS. 5A to 5C are flowcharts illustrating a navigation method in one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, some forms of the present disclosure will be described in detail with reference to the exemplary drawings. In adding the reference numerals to the components of each drawing, it should be noted that the identical or equivalent component is designated by the identical numeral even when they are displayed on other drawings. Further, in describing some forms of the present disclosure, a detailed description of the related known configuration or function will be omitted when it is determined that it interferes with the understanding of some forms of the present disclosure.

In describing the components of some forms of the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

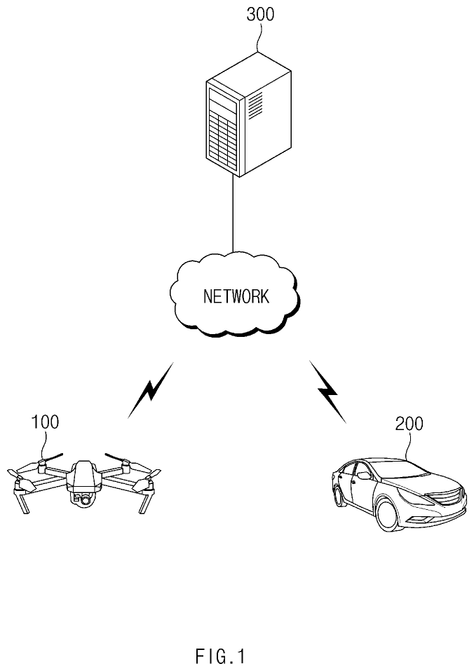

FIG. 1 is a block diagram illustrating a navigation system in some forms of the present disclosure.

Referring to FIG. 1, a navigation system includes a drone 100, a vehicle 200, and a navigation server 300.

The drone 100, which is an unmanned aerial vehicle (UAV), moves to a specified location (point) based on an instruction of the navigation server 300 to obtain peripheral road information. The drone 100 may obtain road information using sensing means mounted thereto. The drone 100 transmits the obtained road information in real time or in a predetermined transmission period (e.g., 3 minutes or the like) to the navigation server 300.

For example, the drone 100 obtains the road information within a predetermined range of a distance (e.g., about 5 to 10 km) forward from the vehicle 200 based on the instruction of the navigation server 300 and transmits the obtained road information to the navigation server 300. Alternatively, the drone 100 moves to a congested section based on the instruction of the navigation server 300 to obtain road information around the congested section, and transmits the obtained road information to the navigation server 300.

The vehicle 200 receives a driving route from the navigation server 300 and guides a route to a driver based on the driving route. The vehicle 200 measures a vehicle position in real time or in a predetermined transmission period while driving along the driving route and transmits the vehicle position to the navigation server 300.

The navigation server 300 may serve as a ground control system for tracking a flight trajectory of the drone 100 and controlling a flight of the drone 100.

The navigation server 300 collects traffic information from a roadside terminal (not shown) installed at a roadside and stores and manages the collected traffic information as a database. The roadside terminal (not shown) obtains the traffic information of the road via sensing devices such as a loop coil, a camera, a radar sensor, and the like installed at a predetermined position on the road. When there is a route search request from the vehicle 200, the navigation server 300 searches (generates) a driving route by reflecting the traffic information. The navigation server 300 transmits the searched driving route to the vehicle 200 requested the route search.

The navigation server 300 detects the congested section using the traffic information and map information and obtains the road information around the congested section using the drone 100. In this connection, the navigation server 300 may detect the congested section using the drone 100. The navigation server 300 generates a detour lane and/or a detour route based on the road information obtained through the drone 100. The navigation server 300 provides (guides) the generated detour lane and/or detour route to the vehicle 200, wherein the congested section on the driving route is located ahead of the vehicle 200.

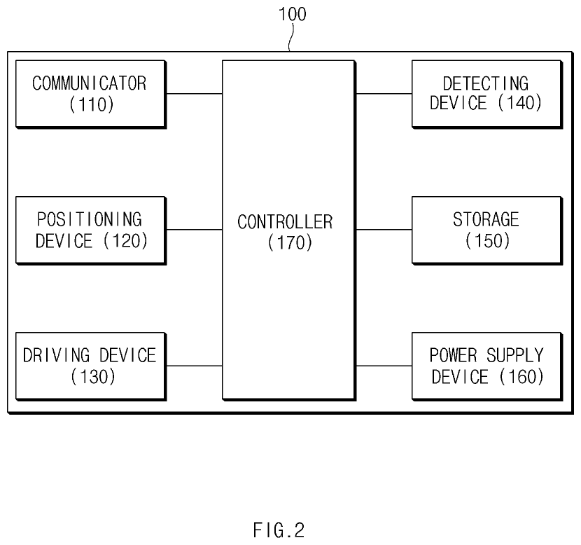

FIG. 2 is a block diagram illustrating the drone 100 shown in FIG. 1.

In FIG. 2, the drone 100 includes a communicator 110, a positioning device 120, a driving device 130, a detecting device 140, storage 150, a power supply device 160, and a controller 170.

The communicator 110 performs communication with the vehicle 200 and the navigation server 300. The communicator 110 may use a communication technology such as wireless internet, short-range communication, and/or mobile communication. As the wireless Internet technology, a wireless LAN (WLAN) (Wi-Fi), a wireless broadband (Wibro), and the like may be used. As the short-range communication technology, a Bluetooth, a near field communication (NFC), a Radio Frequency Identification (RFID), a ZigBee, and the like may be used. As the mobile communication technology, a code division multiple access (CDMA), a global system for mobile communication (GSM), a long term evolution (LTE), an international mobile telecommunication-2020 (IMT), and the like may be used.

The positioning device 120 measures a current position, that is, a position of the drone 100. The positioning device 120 may be implemented as a global positioning system (GPS) receiver. The positioning device 120 may calculate the current position of the drone 100 using a signal transmitted from at least three GPS satellites.

The driving device 130 controls a motor output, that is, a rotational speed of a motor based on a control command (control signal) of the navigation server 300 received via the communicator 110. The driving device 130 may be implemented as an electronic speed controller (ESC). The motor is driven under control of the driving device 130 and coupled with a propeller to rotate together. The driving device 130 controls the flight of the drone 100 using a difference in a rotation speed of the propeller.

The detecting device 140 obtains information around the drone via various sensors mounted on the drone 100. The detecting device 140 may obtain image information around the drone via a camera (not shown) mounted on the drone 100. In addition, the detecting device 140 may obtain the information around the drone 100 via a radio detecting and ranging (radar) and/or a light detection and ranging (LiDAR), or the like.

The storage 150 may store the information obtained (detected) by the detecting device 140. The storage 150 may store a flight route of the drone 100 received via the communicator 110. The flight route may be provided from the navigation server 300. In addition, the storage 150 may store software programmed for the controller 170 to perform a predetermined operation. The storage 150 may be implemented as at least one of storage media (recording media) such as a flash memory, a hard disk, an SD card (Secure Digital Card), a random access memory (RAM), a read only memory (ROM), an electrically erasable and programmable ROM (EEPROM), an erasable and programmable ROM (EPROM), a register, a removable disk, and/or the like.

The power supply device 160 supplies power necessary for an operation of each of the components mounted on the drone 100. The power supply device 160 receives the power from a battery, a fuel cell, or the like mounted in the drone 100 and supplies the power to each component.

The controller 170 transmits (delivers) motion information obtained via various sensors (e.g., a gyro, an acceleration sensor, an atmospheric pressure sensor, an ultrasonic sensor, a magnetometer, an optical flow and sound wave detector, or the like) mounted on the drone 100 and position information obtained via the positioning device 120 to the driving device 130. In addition, the controller 170 may receive the control signal transmitted from the navigation server 300 via the communicator 110 and transmit the received control signal to the driving device 130.

The controller 170 obtains the information around the drone 100, for example, the image information, via the detecting device 140. The controller 170 transmits the obtained peripheral information to the navigation server 300 via the communicator 110. At this time, the controller 170 transmits the road information obtained by the detecting device 140 to the navigation server 300 in real time or in a predetermined transmission period.

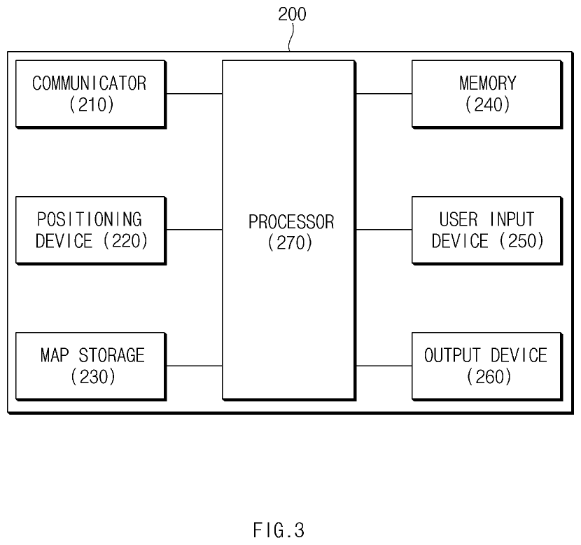

FIG. 3 is a block diagram of the vehicle 200 shown in FIG. 1.

Referring to FIG. 3, the vehicle 200 may include a communicator 210, a positioning device 220, map storage 230, a memory 240, a user input device 250, an output device 260, and a processor 270.

The communicator 210 performs communication with the drone 100 and the navigation server 300. The communicator 210 may use a communication technology such as wireless Internet, short-range communication, mobile communication, and/or vehicle communication (Vehicle to Everything, V2X). As the V2X technology, a communication between a vehicle and a vehicle (V2V: Vehicle to Vehicle), a communication between a vehicle and an infrastructure (V2I: Vehicle to Infrastructure), a communication between a vehicle and a mobile device (V2N: Vehicle-to-Nomadic Devices), and/or an in-vehicle communication (IVN: In-Vehicle Network), and the like may be applied.

The positioning device 220 measures a current position, that is, a position of the vehicle. The positioning device 220 may measure the vehicle position using at least one of positioning technologies such as a Global Positioning System (GPS), a Dead Reckoning (DR), a Differential GPS (DGPS), a Carrier Phase Differential GPS (CDGPS), and/or the like.

The map storage 230 may store map information (map data) such as a precision map or the like. The map information may be automatically updated at predetermined update periods through the communicator 210 or manually updated by the user. The map storage 230 may be implemented as at least one of storage media such as a flash memory, a hard disk, an SD card (Secure Digital Card), a random access memory (RAM), a web storage, and/or the like.

The memory 240 may store a program for an operation of the processor 270. The memory 240 may store a road guidance algorithm or the like. The memory 240 may store a driving trajectory of the vehicle 200 measured by the positioning device 220 and the driving route received through the communicator 210. The memory 240 may be implemented as at least one of storage media (recording media) such as a flash memory, a hard disk, an SD card (Secure Digital Card), a random access memory (RAM), a static random access memory (SRAM), a read only memory (ROM), a programmable read only memory (PROM), an electrically erasable and programmable ROM (EEPROM), an erasable and programmable ROM (EPROM), a register, a removable disk, and/or the like.

The user input device 250 generates data based on manipulation of the user (e.g., driver). For example, the user input device 250 generates data requesting search of a route to a destination based on user input. The user input device 250 may be implemented as a keyboard, a keypad, a button, a switch, a touch pad, and/or a touch screen.

The output device 260 may output progress and/or results based on an operation of the processor 270 in a form of visual, auditory, and/or tactile information. The output device 260 may include a display, an audio output module, and/or a haptic module, or the like. The display may include at least one of a liquid crystal display (LCD), a thin film transistor-liquid crystal display (TFT LCD), an organic light-emitting diode (OLED) display, a flexible display, a 3D display, a transparent display, a head-up display (HUD), a touch screen, and/or a cluster. The audio output module, which plays and outputs audio data stored in the memory 240, may be implemented as a speaker or the like. The haptic module controls a vibration intensity, a vibration pattern, and the like of a vibrator to output a tactile signal (e.g., vibration) that may be perceived by the user using tactile sensation. In addition, the display may be implemented as a touch screen combined with a touch sensor, and thus may be used as an input device as well as the output device.

The processor 270 controls an operation of a navigation function mounted on the vehicle 200. The processor 270 may be implemented as at least one of an application specific integrated circuit (ASIC), a digital signal processor (DSP), a programmable logic device (PLD), field programmable gate arrays (FPGAs), a central processing unit (CPU), microcontrollers, and/or microprocessors.

The processor 270 may set a destination in accordance with a user input transmitted from the user input device 250. When the destination is set, the processor 270 transmits a request for searching a route from the vehicle position identified by the positioning device 220 to the destination to the navigation server 300. That is, the processor 270 transmits a route search request message including information on the vehicle position, the destination, and the like to the navigation server 300.

Thereafter, the processor 270 receives the driving route from the navigation server 300 and guides the route to the destination. The processor 270 measures the vehicle position via the positioning device 220 while the vehicle 200 travels along the driving route and transmits the measured vehicle position to the navigation server 300 in real time or in a predetermined transmission period.

When detour lane information (e.g., including a detour lane position) is received from the navigation server 300 while the vehicle 200 travels along the driving route, the processor 270 maintains the existing driving route and induces (guides) the vehicle 200 to change a lane to the detour lane. When a congested section due to an unexpected situation such as an accident or the like occurs in front of the vehicle 200, the navigation server 300 guides the detour lane to the vehicle 200.

Further, when a new driving route including a detour route is received from the navigation server 300 while the vehicle 200 travels along the driving route, the processor 270 updates the existing driving route stored in the memory 240 with the new driving route. The processor 270 performs route guidance based on the new driving route. When the congested section occurs in front of the vehicle 200 for reasons other than the unexpected situation, the navigation server 300 guides the vehicle 200 the new driving route including the detour route.

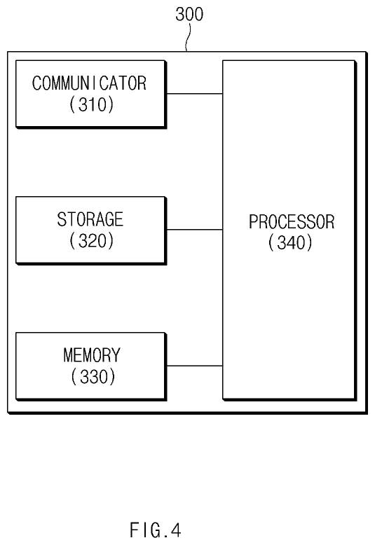

FIG. 4 is a block diagram of the navigation server 300 shown in FIG. 1.

As shown in FIG. 4, the navigation server 300 includes a communicator 310, storage 320, a memory 330, and a processor 340.

The communicator 310 allows communication with the drone 100 and the vehicle 200. The communicator 310 may use a communication technology such as wireless Internet, short-range communication, mobile communication, and/or vehicle communication (Vehicle to Everything, V2X). The communicator 310 may receive image information and the like transmitted from the drone 100 and may transmit control information (control signal) for manipulating the drone 100. The communicator 310 may receive the route search request from the vehicle 200, search for the driving route, and transmit the driving route to the vehicle 200.

The storage 320 may store the traffic information and the map information in the database form. The storage 320 may be implemented as at least one of storage media (recording media) such as a hard disk, a magnetic disk, a magnetic tape, an optical disk, a removable disk, a web storage, and/or the like.

The memory 330 stores software programmed for the processor 340 to perform a predetermined operation. The memory 330 may store a route generation (estimation) algorithm, an image analysis algorithm, and the like. The memory 330 may store preset setting information. The memory 330 may be implemented as at least one of storage media (recording media) such as a flash memory, a hard disk, an SD card (Secure Digital Card), a random access memory (RAM), a static random access memory (SRAM), a read only memory (ROM), a programmable read only memory (PROM), an electrically erasable and programmable ROM (EEPROM), an erasable and programmable ROM (EPROM), a register, a removable disk, and/or the like.

The processor 340 controls overall operations of the navigation server 300. The processor 340 may include at least one of an application specific integrated circuit (ASIC), a digital signal processor (DSP), a programmable logic device (PLD), field programmable gate arrays (FPGAs), a central processing unit (CPU), microcontrollers, and/or microprocessors.

The processor 340 collects the traffic information through the sensing devices (e.g., the loop coil, the camera, the radar sensors, and the like) installed at the specific location on the road in a predetermined collection period, and updates the traffic information stored in the storage 320 by reflecting the collected traffic information.

The processor 340 detects the congested section occurred on the road by associating the traffic information with the map information. In addition, the processor 340 may obtain the image information via the camera mounted on the drone 100 and analyze the obtained image information to detect the congested section. When the occurrence of the congested section is identified (recognized) on the road, the processor 340 obtains the road information of the congested section using the drone 100. The processor 340 transmits a flight route including a location coordinate (location information) of the congested section to the drone 100. The drone 100 aviates along the flight route and moves to the congested section. When arriving at the congested section, the drone 100 obtains the image information around the congested section via the camera and transmits the obtained image information to the navigation server 300.

The processor 340 analyzes the image information obtained through the drone 100 to determine whether the accident has occurred in the congested section. In other words, the processor 340 analyzes the image information to determine whether a reason of the congestion is the occurrence of the accident such as vehicle overturning, vehicle stopping, vehicle crash, and/or fire.

When the accident occurs in the congested section, the processor 340 identifies an accident lane based on the image information. When the accident lane is identified, the processor 340 transmits accident lane information to the vehicles 200 located within a predetermined distance from an accident point based on the driving route. The accident lane information may include a location of the accident and/or a type of accident. When the accident lane information is received, the vehicle 200 outputs a notification, such as ‘accident occurred on second-lane near 50 m ahead’ to the output device 260 based on the accident lane information.

Further, the processor 340 may detect a congested lane among lanes in the congested section based on the image information when no accident occurred in the congested section.

In addition, the processor 340 detects the detour lane to avoid the accident lane (or congested lane) in the congested section based on the image information. The processor 340 extracts a lane in which the vehicles 200 travel at or above a reference vehicle speed (a first reference speed) among lanes in the congested section. For example, when the vehicles are congested at or below 10 km/h in lanes 1 to 3 among the lanes in the congested section and when the vehicles are going slow at or above 30 km/h in a lane 4, the processor 340 may determine the lane 4 as the detour lane. The processor 340 may compare a driving speed in the accident lane or the congested lane with driving speeds of other lanes in the congested section, and select a lane with the driving speed, which is different from the driving speed in the accident lane or the congested lane by a second reference speed or above, as the detour lane. The first reference speed and the second reference speed are set in advance by a system designer.

The processor 340 transmits information on the detour lane, that is, detour lane information, to the vehicles 200 heading to the congested section on the driving route. The processor 270 of the vehicle 200 induces a lane change to the detour lane based on the existing driving route stored in the memory 240.

When there is no detour lane in the map information, the processor 340 determines whether a new road exists by associating the image information with the map information. The processor 340 extracts a road (road section) from the image information and maps the extracted road to the map information to extract (separate) a new road that does not exist on the map. The processor 340 determines whether an end-to-end of the new road is connected to a road on the route to the destination of the vehicle 200. When the end-to-end of the new road is connected to the road on the route to the destination of the vehicle 200, the processor 340 determines whether the road is a road drivable by the vehicle based on a road width, a road condition, and the like of the new road.

When the new road is the road drivable by the vehicle, the processor 340 generates a detour route using the new road as a detour road and generates a new driving route including the detour route. The processor 340 compares the new driving route with the existing driving route based on a driving route selection criterion, selects one driving route, and provides (guides) the selected driving route to the vehicle 200.

In other words, when a priority is given to driving time when selecting the driving route, the processor 340 calculates a driving time in the new driving route, compares the driving time in the new driving route with a driving time in the existing driving route, and selects a driving route with minimum driving time as an optimum route.

Further, when a priority is given to a driving distance when selecting the driving route, the processor 340 calculates a driving distance in the new driving route and a driving distance in the existing driving route to compare with each other, and selects a driving route with minimum driving distance as an optimum route. Then, the processor 340 transmits the selected optimum route to the vehicle 200.

The processor 340 may provide, to the vehicle 200, weather information, road state information, driving environment information, and/or front tunnel information analyzed based on the road information obtained by the drone 100. The vehicle 200 may provide an optimum driving environment to the driver in consideration of information such as the weather information, the road state information, the driving environment information, and/or the front tunnel information. For example, the vehicle 200 may automatically operate or stop a wiper based on the weather information. Alternatively, the vehicle 200 may close a window and turn on a head lamp when the window is opened before entering a tunnel based on the front tunnel information, and restore the window to a previous state and turn off the head lamp when the tunnel has been passed through.

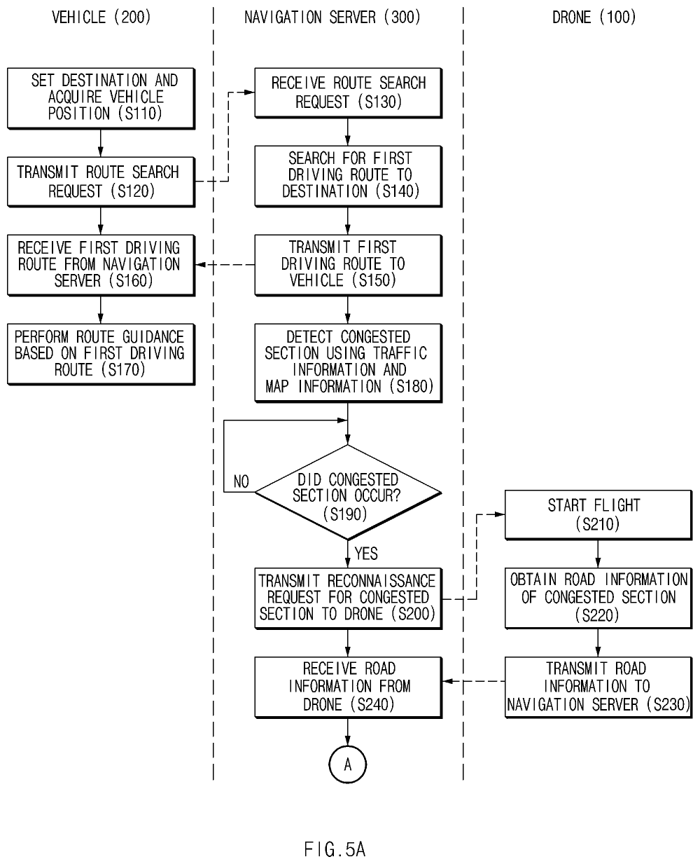

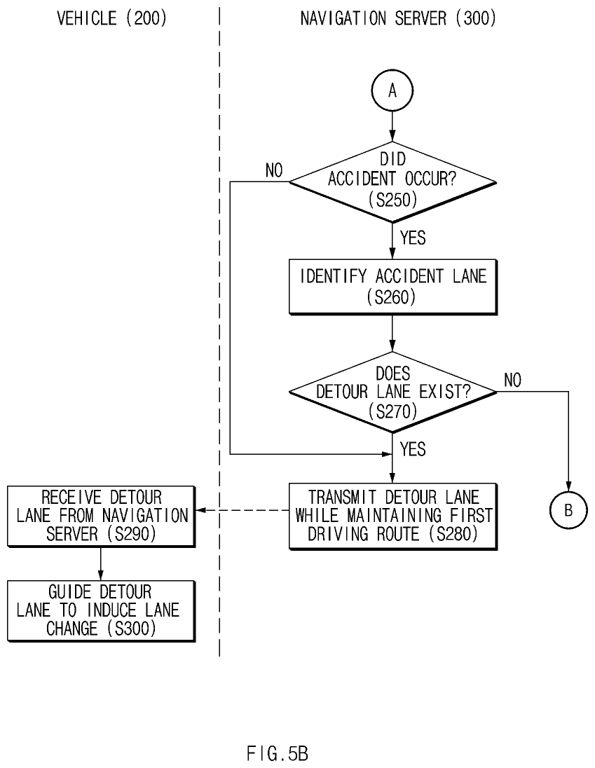

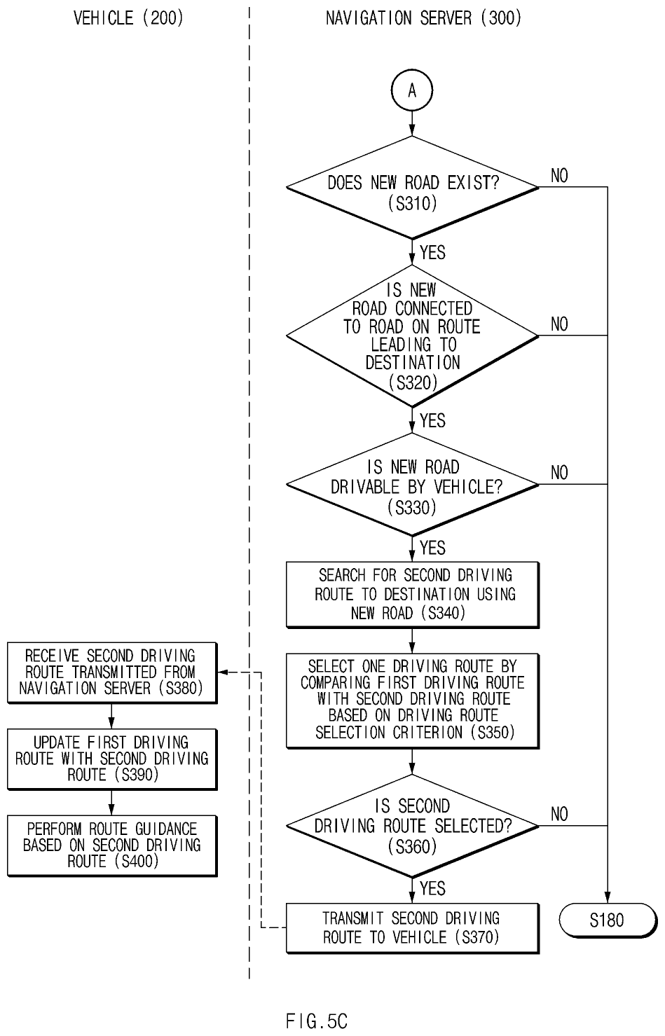

FIGS. 5A to 5C are flowcharts illustrating a navigation method in some forms of the present disclosure. In some forms of the present disclosure, the navigation server 300 provides a navigation service to one vehicle 200 to help understanding of the present disclosure, but the present disclosure is not limited thereto. The navigation server 300 may provide the navigation service to at least two vehicles 200.

The vehicle 200 sets the destination and acquires the vehicle position (S110). The processor 270 of the vehicle 200 sets the destination based on the user input received from the user input device 250. In addition, the processor 270 measures the current position of the vehicle, that is, the vehicle position, via the positioning device 220.

When the destination is set, the vehicle 200 transmits the route search request to the navigation server 300 (S120). The processor 270 of the vehicle 200 transmits the route search request including the information such as the vehicle position, the destination, and the like via the communicator 210.

The navigation server 300 receives the route search request from the vehicle 200 (S130). The processor 340 of the navigation server 300 receives the route search request transmitted from the vehicle 200 via the communicator 310.

The navigation server 300 searches for a first driving route from the vehicle position to the destination (S140). The processor 340 generates (estimates) candidate routes from the vehicle position to the destination based on the traffic information and the map information stored in the storage 320. The processor 340 calculates a distance, a time required, and/or a cost of each candidate route. The processor 340 selects a candidate route having a minimum distance, a minimum time, and/or a minimum cost as the optimum route, that is, the first driving route, based on driving route selection criteria.

The navigation server 300 transmits the found first driving route to the vehicle 200 (S150). The processor 340 transmits the first driving route via the communicator 310.

The vehicle 200 receives the first driving route from the navigation server 300 (S160). The processor 270 receives the first driving route via the communicator 210 and stores the first driving route in the memory 240.

The vehicle 200 performs the route guidance based on the first driving route (S170). The processor 270 of the vehicle 200 guides the route along the first driving route to the destination and maps the current position of the vehicle on the map to display the current position on the display. The processor 270 transmits the vehicle position measured by the positioning device 220 to the navigation server 300 based on the preset transmission period.

Thereafter, the navigation server 300 detects the congested section using the traffic information and the map information stored in the storage 320 (S180). The processor 340 detects a road section in which the vehicle driving speed is less than or equal to a congestion determination reference speed as the congested section based on the traffic information. Although some forms of the present disclosure disclose detecting the congested section using the traffic information and the map information, the present disclosure is not limited thereto, and the navigation server 300 may detect the congested section using the image information obtained by the drone 100.

The navigation server 300 determines whether the congested section occurred based on the congested section detection result (S190). That is, the navigation server 300 determines that the congested section occurred when the congested section is detected, and determines that the congested section did not occur when the congested section is not detected.

When the congested section occurs, the navigation server 300 requests the drone 100 for reconnaissance of the congested section (S200). The processor 340 transmits a congested section reconnaissance request together with location information of a start point and an end point of the congested section.

When the reconnaissance request is received from the navigation server 300, the drone 100 starts the flight (S210). The controller 170 of the drone 100 controls the driving device 130 to allow the drone 100 to reach the congested section.

The drone 100 obtains the road information of the congested section through the detecting device 140 (S220). When the drone 100 arrives at the congested section, the controller 170 activates the camera mounted on the drone 100 to obtain the image information around the congested section.

The drone 100 transmits the road information of the congested section to the navigation server 300 (S230). That is, the controller 170 of the drone 100 transmits the road information including the image information through the communicator 110.

The navigation server 300 receives the road information from the drone 100 (S240). The processor 340 of the navigation server 300 may store the received road information in the memory 330.

The navigation server 300 determines whether the accident occurred based on the road information (S250). The processor 340 analyzes the image information included in the road information and determines whether the accident occurred in the congested section.

The navigation server 300 identifies the accident lane based on the road information when the occurrence of the accident is identified (S260). The processor 340 extracts (detects) the accident lane from the image information through image processing. The processor 340 transmits the information on the accident lane, that is, the accident lane information (e.g., including the location of the accident lane) to the vehicle 200. The vehicle 200 notifies the driver of the occurrence of the accident in front of the vehicle 200 based on the accident lane information.

The navigation server 300 identifies the existence of the detour lane based on the road information when the accident lane is identified (S270). The processor 340 identifies lanes in the congested section from the image information and calculates a vehicle driving speed for each lane. The processor 340 determines a lane in which the vehicle driving speed is equal to or greater than the first reference speed (detour lane determination reference speed) or a lane with the driving speed which is different from the driving speed in the accident lane (or congested lane) by the second reference speed or above among other lanes in the congested section, as the detour lane.

On the other hand, when no accident occurred in the congested section, the processor 340 analyzes the image information to distinguish the lanes in the congested section and identifies the vehicle driving speed for each lane. The processor 340 selects the lane in which the vehicle driving speed is equal to or greater than the detour lane determination reference speed as the detour lane.

When the detour lane exists, the navigation server 300 maintains the first driving route, but transmits the information on the detour lane, that is, the detour lane information to the vehicle 200 (S280). In other words, the processor 340 of the navigation server 300 transmits only the detour lane information to the vehicle 200 and does not transmit the first driving route.

The vehicle 200 receives the detour lane information from the navigation server 300 (S290). The processor 270 of the vehicle 200 may receive the detour lane information including information including a position of the detour lane and the like through the communicator 210 and store the detour lane information in the memory 240.

The vehicle 200 guides the detour lane to induce the lane change (S300). The vehicle 200 induces the lane change to the detour lane when the vehicle is not located on the detour lane.

When there is no detour lane in the map information, the navigation server 300 identifies the existence of the new road by associating the road information with the map information (S310). The processor 340 extracts the road in the image information by performing the image processing on the image information provided from the drone 100, and maps the extracted road to the map information to extract (detect) a road that is not reflected in the map information as the new road.

When the new road exists, the navigation server 300 determines whether the new road is connected to the road on the route leading to the destination (S320). The processor 340 determines whether the end-to-end of the new road is connected to the road on the route leading to the destination of the vehicle 200.

When the new road is connected to the road on the route leading to the destination, the navigation server 300 determines whether the new road is the road drivable by the vehicle (S330). The processor 340 determines whether the new road is the road drivable by the vehicle, in consideration of the road width, the road condition, and the like of the new road, based on the image information.

When the new road is the road drivable by the vehicle, the navigation server 300 searches for the second driving route to the destination using the new road (S340). The processor 340 generates (calculates) the detour route using the new road as the detour road and generates the second driving route (new driving route) including the detour route.

The navigation server 300 selects one driving route by comparing the first driving route (existing driving route) with the second driving route based on the driving route selection criterion (S350). For example, the processor 340 compares the driving time of the first driving route with the driving time of the second driving route and selects the driving route having the shorter driving time as the optimum route.

The navigation server 300 determines whether the selected driving route is the second driving route (S360). The processor 340 determines whether the driving route different from the first driving route, that is, the second driving route is selected.

When the selected driving route is the second driving route, the navigation server 300 transmits the second driving route to the vehicle 200 (S370). The vehicle 200 receives the second driving route transmitted from the navigation server 300 (S380). The vehicle 200 updates the first driving route stored in the memory 240 with the second driving route (S390). The vehicle 200 performs the route guidance based on the second driving route (S400).

In some forms of the present disclosure, it has been described that, when the detour road does not exist in the map information, the new road that does not exist in the map information is detected using the image information obtained through the drone 100. However, the present disclosure is not limited thereto. The present disclosure may be implemented to detect the new road through the image information when identifying the existence of the detour road.

The description above is merely illustrative of the technical idea of the present disclosure, and various modifications and changes may be made by those skilled in the art without departing from the essential characteristics of the present disclosure. Therefore, some forms of the present disclosure are not intended to limit the technical idea of the present disclosure but to illustrate the present disclosure, and the scope of the technical idea of the present disclosure is not limited by some forms of the present disclosure. The scope of the present disclosure should be construed as being covered by the scope of the appended claims, and all technical ideas falling within the scope of the claims should be construed as being included in the scope of the present disclosure.

According to the present disclosure, since the traffic information is obtained in real time without limiting the road section using the drone and the driving route is guided by reflecting the obtained traffic information, the driving route may be searched by reflecting real-time traffic information at a time point of searching the route.

Furthermore, according to the present disclosure, since a driving vision is expanded through the drone, driving safety may be improved by securing wide traffic information in front of the vehicle.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A navigation system comprising:
a communicator configured to communicate with a drone and a vehicle;
storage configured to store traffic information and map information; and
a processor configured to:
detect a congested section using the traffic information and the map information, or image information of the drone; and
guide a detour lane or a detour route to the vehicle based on road information of the congested section obtained by the drone.

2. The navigation system of claim 1, wherein the road information includes the image information captured through a camera mounted on the drone.

3. The navigation system of claim 2, wherein the processor is configured to:
analyze the image information;
identify an accident occurrence in the congested section; and
identify an accident lane.

4. The navigation system of claim 3, wherein the processor is configured to:
identify the detour lane for avoiding the accident lane; and
transmit the detour lane to the vehicle.

5. The navigation system of claim 4, wherein the processor is configured to:
determine that one of a first lane or a second lane is the detour lane, wherein the first lane has a vehicle driving at a speed equal to or greater than a first reference speed and the second lane has a vehicle driving at a speed that differs from the vehicle driving in the accident lane by more than a second reference speed.

6. The navigation system of claim 2, wherein the processor is configured to:
identify a detour road by associating the image information with the map information.

7. The navigation system of claim 2, wherein the processor is configured to:
extract a road from the image information;
map the extracted road to the map information; and
determine that a road that does not exist in the map information is a new road.

8. The navigation system of claim 7, wherein the processor is configured to:
determine whether the new road is a road drivable by the vehicle; and
determine whether the new road is able to be used as a detour road.

9. The navigation system of claim 8, wherein the processor is configured to:
determine that the new road is able to be used as the detour road when an end-to-end of the new road is connected to a road to a destination of the vehicle.

10. The navigation system of claim 8, wherein the processor is configured to:
generate the detour route using the new road as the detour road;
generate a new driving route including the detour route to calculate a driving time; and
provide the new driving route to the vehicle when the driving time of the new driving route is shorter than a driving time of an existing driving route of the vehicle.

11. A navigation method comprising:
detecting, by a processor, a congested section using traffic information and map information, or image information of a drone;
obtaining, by the drone, road information of the congested section; and
guiding, by the processor, a detour lane or a detour route to a vehicle based on the road information.

12. The navigation method of claim 11, wherein obtaining the road information of the congested section comprises:
obtaining, by a camera mounted on the drone, image information around the congested section as the road information.

13. The navigation method of claim 12, wherein guiding the detour lane or the detour route to the vehicle comprises:
analyzing, by the processor, the image information to identify an occurrence of an accident in the congested section;
identifying, by the processor, an existence of the detour lane for avoiding an accident lane based on the image information when the occurrence of the accident is identified; and
guiding, by the processor, the detour lane to the vehicle.

14. The navigation method of claim 13, wherein identifying the existence of the detour lane comprises:
distinguishing, by the processor, lanes in the congested section based on the image information to calculate a vehicle driving speed for each lane; and
determining, by the processor, that one of a first lane or a second lane is the detour lane, wherein the first lane has the calculated vehicle driving at a speed equal to or greater than a first reference speed and the second lane has the calculated vehicle driving at a speed that differs from the calculated vehicle driving in the accident lane by more than a second reference speed.

15. The navigation method of claim 12, wherein guiding the detour lane or the detour route to the vehicle comprises:
identifying, by the processor, an existence of a new road in the image information by associating the image information with the map information;
generating, by the processor, a new driving route to a destination of the vehicle using the new road;
selecting, by the processor, one driving route by comparing an existing driving route of the vehicle with the new driving route based on a driving route selection criterion; and
guiding, by the processor, the new driving route to the vehicle when the new driving route is selected.

16. The navigation method of claim 15, wherein identifying the existence of the new road comprises:
extracting, by the processor, a road from the image information;
mapping, by the processor, the extracted road to the map information; and
determining, by the processor, that a road that does not exist in the map information is the new road.

17. The navigation method of claim 15, wherein generating the new driving route comprises:
determining, by the processor, whether the new road is able to be used as a detour road; and
when the new road is determined to be used as the detour road, generating, by the processor, the detour route using the new road as the detour road.

18. The navigation method of claim 17, wherein determining whether the new road is able to be used as the detour road comprises:
determining, by the processor, whether an end-to-end of the new road is connected to a road to the destination of the vehicle;
determining, by the processor, whether the vehicle is able to travel based on a road width and a road condition of the new road; and
when the vehicle is determined to travel, determining, by the processor, that the new road is able to be used as the detour road.

19. The navigation method of claim 15, wherein selecting the driving route comprises:
comparing, by the processor, a driving time of the new driving route with a driving time of the existing driving route to select a driving route with a shorter driving time.

20. A navigation system comprising:
a drone;
a vehicle; and
a navigation server configured to connect with the drone and the vehicle through a network,
wherein the vehicle is configured to receive, from the navigation server, a second driving route including a detour lane or a detour route when a congested section occurs in front of the vehicle while traveling along a prestored first driving route, and
wherein the navigation server is configured to collect road information of the congested section using the drone to generate the detour lane or the detour route.
